(19) United States
(12) Patent Application Publication
(10) Pub. No.: US 2026/0221899 A1
(43) Pub. Date: Jul. 30, 2026

(54) PHASE SEQUENCING FOR MULTI-PHASE POWER CONVERTERS

(71) Applicant: Texas Instruments Incorporated, Dallas, TX (US)

(72) Inventors: Vsevolod Igorevich Elantsev, Freising (DE); Riccardo Ruffo, Muenchen (DE)

(21) Appl. No.: 19/248,446

(22) Filed: Jun. 24, 2025

Related U.S. Application Data
(60) Provisional application No. 63/749,954, filed on Jan. 27, 2025.

(51) Int. Cl. H02M 7/5395

(52) U.S. Cl. CPC H02M 7/5395

(57) ABSTRACT

Methods, apparatus, systems, and articles of manufacture are described for phase sequencing for multi-phase power converters. An example system includes interface circuitry configurable to couple to a first phase of a power converter and a second phase of the power converter; and processing circuitry coupled to the interface circuitry and configurable to: enable the first phase while the second phase is disabled; responsive to an output current of the power converter satisfying a first threshold after enabling the first phase, enable the first phase and the second phase; and responsive to the output current not satisfying the first threshold after enabling the second phase, disable the second phase while the first phase is enabled.

### CROSS REFERENCE TO RELATED APPLICATION

This patent application claims the benefit of and priority to U.S. Provisional Patent Application No. 63/749,954 , filed Jan. 27, 2025, which Application is hereby incorporated herein by reference in its entirety. Additionally, U.S. patent application Ser. No. 19/085,454, filed Mar. 20, 2025, is hereby incorporated herein by reference in its entirety.

### TECHNICAL FIELD

This description relates generally to circuits, and, more particularly, to phase sequencing for multi-phase power converters.

### BACKGROUND

Many devices have circuitry to charge batteries of the devices using an external voltage supply. For example, a computer has a connection that may be connected through circuitry to a wall outlet. When plugged in, the power supply coming from the wall outlet can be used to charge the computer battery. Also, in electric or plug in hybrid vehicles, a connector can be attached to the vehicle(s) to charge the vehicle battery using an electrical output of supercharger. To charge the battery of the device without causing damage, a power converter can convert the power source from a first voltage to a second voltage that is safe for charging the battery.

Some devices utilize multiphase power converters to deliver power to a load. Multiphase power converters are end-equipment that use two or more out-of-phase power converter stages (also referred to as phases). Multiphase power converters are used to convert a first, input voltage to a second, output voltage. Multiphase power converters correspond to a smooth and continuous output. Multiphase power converters can be used in computer power supplies, automotive systems, battery charging, etc. In some examples, multiphase power converters are used in high output current scenarios.

### SUMMARY

For phase sequencing for multi-phase power converters, an example device includes interface circuitry configurable to couple to a first phase of a power converter and a second phase of the power converter; and processing circuitry coupled to the interface circuitry and configurable to: enable the first phase while the second phase is disabled; responsive to an output current of the power converter satisfying a first threshold after enabling the first phase, enable the first phase and the second phase; and responsive to the output current not satisfying the first threshold after enabling the second phase, disable the second phase while the first phase is enabled. Other examples are described.

For phase sequencing for multi-phase power converters, an example method includes enabling a first phase of a power converter while a second phase of the power converter is disabled; responsive to an output current of the power converter satisfying a first threshold after enabling the first phase, enabling the first phase and the second phase; and responsive to the output current not satisfying the first threshold after enabling the second phase, disabling the second phase while the first phase is enabled. Other examples are described.

For phase sequencing for multi-phase power converters, an example system includes a power converter including a first phase circuit configurable to generate a first current and a second phase circuit configurable to generate a second current, wherein a total output current of the power converter corresponds to a sum of the first current and the second current; and a controller configurable to: enable the first phase circuit while the second phase circuit is disabled; responsive to the total output current satisfying a threshold after enabling the first phase circuit, enable the first phase circuit and the second phase circuit; and responsive to the total output current not satisfying the threshold after enabling the second phase circuit, disable the second phase circuit while the first phase circuit is enabled. Other examples are described.

### BRIEF DESCRIPTION OF THE DRAWINGS

FIG. 1 is a diagram of various types of contactors in an EV or HEV environment.

FIG. 2 is an example circuit to perform phase sequencing for a multi-phase power converter.

FIG. 3 is an example block diagram to implement the phase sequencing circuitry of FIG. 2.

FIG. 4 is an example circuit to implement the phase sequencing circuitry of FIG. 2.

FIG. 5 is a flowchart representative of a method, instructions, and/or operations that may be executed to implement the phase sequencing circuitry of FIGS. 2, 3, and/or 4.

FIG. 6 is an example diagram illustrating phase sequencing in conjunction with examples described herein.

FIG. 7 is an example timing diagram illustrating currents of the multi-phase power converter of FIG. 2.

FIG. 8 illustrates a comparison of efficiency of some multi-phase power converters to the efficiency of the multi-phase power converter of FIG. 2.

FIG. 9 is an example graph illustrating the efficiency of a phase of the multi-phase power converter with respect to the current output by the phase.

FIG. 10 is a block diagram of an example processing platform including programmable circuitry structured to execute, instantiate, and/or perform the example machine readable instructions and/or perform the example operations of FIG. 5 to implement the phase sequencing circuitry of FIG. 3.

The same reference numbers or other reference designators are used in the drawings to designate the same or similar (functionally and/or structurally) features.

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

### DETAILED DESCRIPTION

Power conversion systems, such as multiphase power converters, are used to charge batteries and/or store charge in a plurality of systems. For example, power conversion systems may be implemented in solar microinverters, energy storage systems, power grids, power converters for solar panels, battery management systems, solar panels, wind turbines, other power generation systems (e.g., hydrocarbon, hydroelectric, nuclear, etc.), DC chargers for computing devices, DC chargers for electric and/or hybrid vehicles, DC chargers in other systems, power supplies, phone chargers, laptop chargers, any other DC/DC or DC/AC power electronics, etc.

Some power conversion systems utilize a transformer coupled to a first circuit that includes a power supply and a plurality of switches (e.g., in a multiphase structure) and second circuitry that includes a battery or power storage unit and a second plurality of switches (e.g., in a rectifier structure). Such power conversion systems can convert the DC voltage of the power supply to an AC signal using the transformer and the first circuit and convert the AC signal to a different DC voltage to charge the battery or power storage unit. Such multi-phase power converter topologies generate an AC current in the winding of the transformer. Also, multi-phase power converters can be used in DC-AC power supplies, in both soft and hard switching topologies.

When some multi-phase power converters are implemented, a controller enables all the phases of the power converter at the same time at the beginning of a switching cycle. For example, the controller outputs pulse width modulated signals to the transistors of all phases at the same time as soon as a switching cycle of the power converter is initiated and throughout operation, where the pulse-width modulated signal for each phase is phase-shifted. When a phase is first enabled, the efficiency of the phase is very low and it takes time for the efficiency of the phase to reach its maximum efficiency. Accordingly, by enabling all phases at the same time, the efficiency of each phase is low for a duration of time. Low efficiency of a phase results in more heat, thereby requiring a larger heat sink.

Examples described herein provide a phase sequencing protocol that is more efficient than enabling all phases at the same time. Examples described herein maximize the most efficient region in each phase of a multiphase power converter using phases on-demand. For example, instead of enabling all phases at the same time from the beginning (e.g., the beginning of a switching cycle), examples described herein enable a first phase until the phase reaches a threshold amount of efficiency. The threshold amount of efficiency may be based on an amount of total output current of the power converter. After the first phase reaches the threshold amount of efficiency, examples described herein enable a second phase of the power converter until the second phase converter reaches a threshold amount of efficiency. After the efficiency of each phase reaches the threshold, an additional phase is enabled. As used herein, enabling a phase means initiating (a) a first pulse width modulated signal to the high side transistor of a phase and (b) a second pulse width modulated signal to the low side transistor of the phase. The first pulse width modulated (PWM) signal and the second pulse width modulated signal are created so that both the high side transistor and the low side transistor are not conducting at the same time, e.g., by ensuring dead time to prevent shoot-through current. In this manner, the output of the phase corresponds to an increasing voltage for a first duration of time and a decreasing voltage for a second duration of time. Examples described herein result in an increase in efficiency which causes significantly less heat loss. Accordingly, examples described herein allow the power converter to have a smaller heat sink. For example, a 1% increase in efficiency can result in a heat sink that is half the size of no increase in efficiency. Also, examples described herein can be performed without additional components (via a controller/software implementation of examples described herein), potentially reducing the cost of the device. Moreover, the techniques of this disclosure may consume a modest amount of processing resources, such that more expensive processing circuitry is not required.

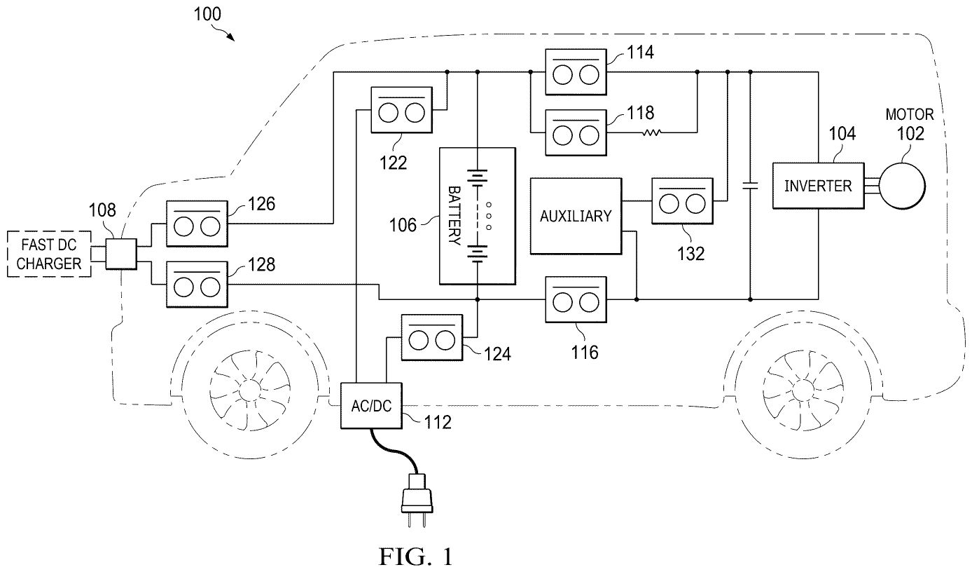

FIG. 1 is a schematic diagram of a vehicle 100, which is an electric vehicle (EV) or hybrid electric vehicle (HEV), showing various types of contactors that may be used in such a vehicle. The illustration may be over inclusive in that not all of the contactors shown are necessarily used in either an EV or an HEV. The illustration is intended to give non-exhaustive examples of various contactors.

Vehicle 100 includes a motor 102 and traction inverter 104 coupled to motor 102. Vehicle 100 also includes a battery 106 and a fast DC charge port 108 that is adapted to receive DC charge from an external source. An HEV also includes an AC/DC onboard charger 112.

In the illustrated example, two main contactors 114 and 116 electrically isolate battery 106 and traction inverter 104 when vehicle 100 is switched off for safety. Main contactor 114 is a positive contactor that is disposed between the positive terminal of battery 106 and traction inverter 104. Main contactor 116 is a negative contactor that is disposed between the negative terminal of battery 106 and traction inverter 104. A pre-charge contactor 118 with series-coupled current-limiting resistance is coupled in parallel with main positive contactor 114. Pre-charge contactor 118 is used to charge an initially discharged DC link capacitor before closing main contactors 114 and 116 to avoid a high inrush-current that may damage the battery 106, one or both of main contactors 114 and 116, and/or the DC link capacitor.

When vehicle 100 is an HEV with plug-in charge capability, a pair of additional AC charge contactors 122 and 124 are included to establish connection between battery 106 and AC/DC onboard charger 112, which includes a plug to access an AC electrical source (e.g., an AC electrical outlet), converts that AC electricity to DC electricity to charge the battery 106.

When vehicle 100 is an EV, a pair of DC fast charge contactors 126 and 128 to establish connection between fast DC charge port 108 and battery 106. An auxiliary contactor 132 is included for auxiliary components, e.g., the electric heating/cooling system.

Main contactors 114 and 116, pre-charge contactor 118, and DC charge contactors 126 and 128 are usually located in the battery junction box (or battery disconnect unit), while AC charger contactors 122 and 124 are likely to be placed in the battery power distribution unit, which is typically adjacent to AC/DC onboard charger 112.

When the controller for any of the above-identified contactors is turned-off, current in the load is discharged through a current decay path and as a result power is dissipated to effectuate quick-turn-off (QTO). High-side (HS) and low-side (LS) clamps are used in conjunction with drivers and a control circuit to carry out QTO.

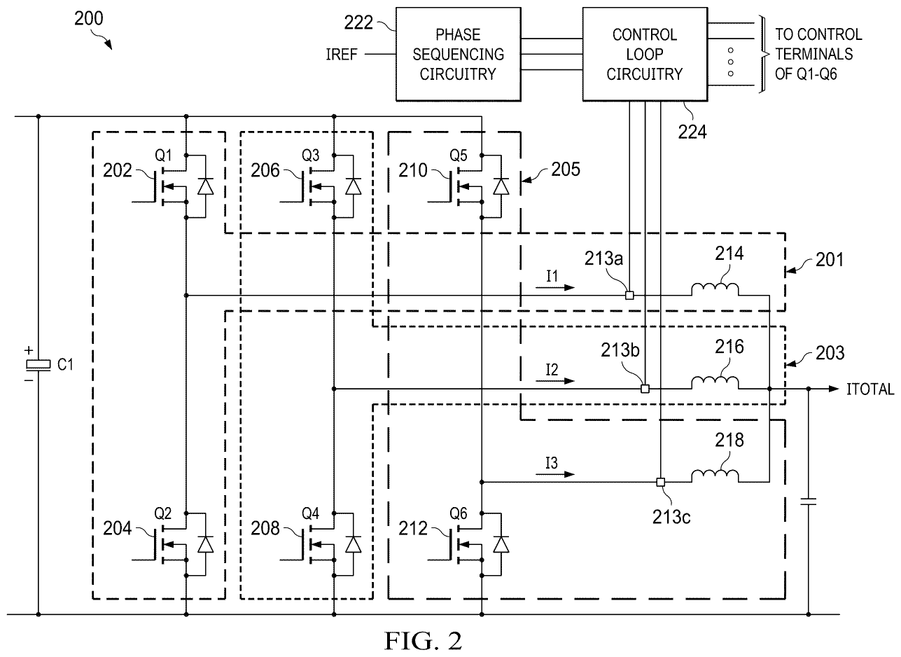

FIG. 2 illustrates an example multi-phase power converter circuit 200 to implement a phase sequencing protocol in conjunction with examples described herein. In some examples, the multi-phase power converter circuit 200 can implement the AC/DC onboard charger 112 of FIG. 1. However, the multi-phase power converter circuit 200 of FIG. 2 can be used in any system that utilizes a multi-phase power converter. The multi-phase power converter circuit 200 of FIG. 2 includes example phases 201, 203, 205, example transistors 202, 204, 206, 208, 210, 212, example current sensors 213a, 213b, 213c, example inductors 214, 216, 218, example phase sequencing circuitry 222, and example control loop circuitry 224. The transistors 202, 204 and the inductor 214 correspond to the first phase 201 of a multi-phase power converter circuit 200, the transistors 206, 208 and the inductor 216 correspond to the second phase 203 of the multi-phase power converter circuit 200, and the transistor 210, 212 and the inductor 218 correspond to the third phase 205 of the multi-phase power converter circuit 200. However, the power converter circuit 200 may include any number of phases (e.g., two or more phases).

The transistors 202, 206, 210 of FIG. 2 (e.g., high side transistors) are a metal oxide semiconductor field effect transistor (MOSTFETs), such an N-channel MOSFETs (NMOSs). However, the transistors 202, 206, 210 can be implemented by any type of transistor and/or switch (e.g., gallium nitride (GaN) transistors, silicon carbide (SiC) FETS, etc.). The transistors 202, 206, 210 are controlled to conduct (e.g., turn on and/or operate in saturation mode to operate as a closed switch) or not conduct (e.g., turn off and/or operate in cutoff mode to operate as an open switch) based on a voltages applied to the control terminals (e.g., gate terminals) of the respective transistors 202, 206, 210. While conducting, the transistors 202, 206, 210 operate as closed switches to cause current to flow to the respective inductors 214, 216, 218 from a supply terminal. The transistors 202, 206, 210 each include a first current terminal (e.g., a drain), a second current terminal (e.g., a source), and a control terminal (e.g., a gate). The first current terminals of the transistors 202, 206, 210 are coupled to the supply terminal. The second current terminal of the transistor 202 is coupled to a first terminal of the inductor 214 and a first current terminal of the transistor 204. The second current terminal of the transistor 206 is coupled to a first terminal of the inductor 216 and a first current terminal of the transistor 208. The second current terminal of the transistor 210 is coupled to a first terminal of the inductor 216 and a first current terminal of the transistor 212. The control terminals of the transistors 202, 206, 210 are coupled to the output terminals of the control loop circuitry 224.

The transistors 204, 208, 212 of FIG. 2 (e.g., low or bottom side transistors) are a metal oxide semiconductor field effect transistor (MOSTFETs), such an N-channel MOSFETs (NMOSs). However, the transistors 202, 206, 210 can be implemented by any type of transistor and/or switch (e.g., GaN transistors, SiC FETS, etc.). The transistors 204, 208, 212 are controlled to conduct (e.g., turn on and/or operate in saturation mode to operate as a closed switch) or not conduct (e.g., turn off and/or operate in cutoff mode to operate as an open switch) based on voltages applied to the control terminals (e.g., gate terminals) of the respective transistors 204, 208, 212. While conducting, the transistors 204, 208, 212 operate as closed switches to cause current to flow from the respective inductors 214, 216, 218 from a ground or common terminal. The transistors 204, 208, 212 each include a first current terminal (e.g., a drain), a second current terminal (e.g., a source), and a control terminal (e.g., a gate). The first current terminal of the transistor 204 is coupled to the first terminal of the inductor 214 and the second current terminal of the transistor 202. The first current terminal of the transistor 208 is coupled to the first terminal of the inductor 216 and the second current terminal of the transistor 206. The first current terminal of the transistor 212 is coupled to the first terminal of the inductor 216 and the second current terminal of the transistor 210. The second current terminals of the transistors 204, 208, 212 are coupled to the ground or common terminal. The control terminals of the transistors 204, 208, 212 are coupled to the output terminals of the control loop circuitry 224.

The inductors 214, 216, 218 store energy while the corresponding transistors 202, 206, 210 are conducting, using the voltage difference between terminals of the inductors 214, 216, 218 to increase current flow. The inductors 214, 216, 218 release stored energy while the corresponding transistor 204, 208, 212 are conducting, resulting in current flowing to and from a load. The current output to and/or from the load is summed to generate a total output current of the power converter circuit 200. The inductors 214, 216, 218 each include two terminals. A first terminal of the inductor 214 is coupled to the second current terminal of the transistor 202 and the first current terminal of the transistor 2045. The first terminal of the inductor 216 is coupled to the second current terminal of the transistor 206 and the first current terminal of the transistor 208. The first terminal of the inductor 218 is coupled to the second current terminal of the transistor 210 and the first current terminal of the transistor 212.

The current sensors 213a, 213b, 213c of FIG. 2 senses (e.g., measures) the output current of each phase of the power converter 200. The first current sensor 213a is coupled to the second current terminal of the transistor 202, the first current terminal of the transistor 204 and the first terminal of the inductor 214 to sense a current for the first phase. The second current sensor 213b is coupled to the second current terminal of the transistor 206, the first current terminal of the transistor 208 and the first terminal of the inductor 216 to sense a current for the second phase. The third current sensor 213c is coupled to the second current terminal of the transistor 210, the first current terminal of the transistor 212 and the first terminal of the inductor 216 to sense a current for the third phase. Also, each of the current sensors 213a, 213b, 213c are coupled to the control loop circuitry 224 to provide the current measurements to the control loop circuitry 224.

The phase sequencing circuitry 222 of FIG. 2 performs a phase sequencing protocol to enable the phases 201, 203, 205 sequentially to increase efficiency. For example, the phase sequencing circuitry 222 can first enable the first phase 201 while the second and third phases 203, 205 are disabled until the first phase 201 has reached a threshold amount of efficiency. After reaching the threshold efficiency, the first phase 201 and the second phase 203 are enabled while the third phase 205 is disabled until the second phase 203 has reached a threshold amount of efficiency. After reaching the threshold efficiency, all the phases 201, 203, 205 are enabled. Likewise, the phase sequencing circuitry 222 disables the phases 201, 203, 205 in reverse order as the efficiency decreases below the threshold(s). The efficiency of the phases 201, 203, 205 can be determined by the manufacturer based on the total current. For example, the manufacturer can determine that the efficiency of the first phase 201 reaches a threshold based on the total current being at or above 5 amps, the efficiency of the second phase 203 reaching the threshold based on the total current being at or above 20 amps, and the efficiency of the third phaser 205 reach the threshold based on the total current being above 25 amps. In such an example, the phase sequencing circuitry 222 can determine when to enable a subsequent stage based on the total output current because the total output current corresponds to the efficiency of the phases. The phase sequencing circuitry 222 obtains a reference current corresponding to the total output current from a terminal or pin that is coupled to a reference node that corresponds to the total output current of the power converter 200.

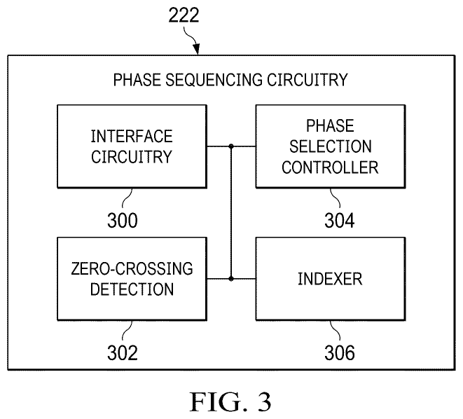

In some examples, the phase sequencing circuitry 222 of FIG. 2 determines when to enable the phases 201, 203, 205 based on a signal from one or more zero voltage detection circuits (not shown). Zero voltage detection circuits trigger an output based on the voltage at the second current terminal of the respective high side transistor being at or near zero, which is the most efficient time to switch. Thus, using zero voltage detection signals can also be used to determine when to enable the phases 201, 203, 205 to increase efficiency. In some examples, zero voltage detection circuitry is included in the high side transistors 202, 206, 210. Also, the phase sequencing circuitry 222 can adjust the order of the enablement for different periods, half periods, etc. of the total output current. For example, if the first phase 201 is always the first phase to be enabled, then the first phase 201 will be operating for longer than the second phase 203, and third phase 205. Thus, the lifetime of the first phase 201 will be shorter, thereby corresponding to a shorter lifetime for the entire power converter circuit 200. Thus, phase sequencing circuitry 222 can extend the lifetime of the converter circuit 200 by switching an enablement order (e.g., the order in which the phases are enabled/disabled), also referred to as an order of enablement), as further described below in conjunction with FIG. 3. The phase sequencing circuitry 222 outputs signals to the control loop circuitry 224 based on the determined phase sequencing. The phase sequencing circuitry 222 is coupled to the control loop circuitry 224 and a terminal that references the total output current of the power converter circuit 200. The phase sequencing circuitry 222 can be implemented by software, as further described below in conjunction with FIG. 2, or by hardware, as further described below in conjunction with FIG. 3.

The control loop circuitry 224 of FIG. 2 generates pulse width modulated signals that are applied to the control terminals of the transistors 202, 204, 206, 208, 210, 212 based on the phase currents from the current sensors 213a, 213b, 213c. For example, while the first phase 201 is enabled (e.g., based on a control signal from the phase sequencing circuitry 222), the control loop circuitry 224 outputs a first PWM signal to the control terminal of the transistor 202 and a second PWM signal to the control terminal of the transistor 204. The first PWM signal and the second PWM signal are generated so that both the transistor 202 and the transistor 204 are not conducting at the same time. The control loop circuitry 224 is coupled to the phase sequencing circuitry 222 and the control terminals of the transistors 202, 204, 206, 208, 210, 212. Additional example details of the control of power converters can be found in commonly assigned U.S. patent application Ser. No. 19/085,454, entitled “Direct Current Balancing Using a Zero Voltage Detection Signal,” filed Mar. 20, 2025, which is incorporated by reference in its entirety.

FIG. 3 is a block diagram of an example implementation of the phase sequencing circuitry 222 of FIG. 2. The phase sequencing circuitry 222 of FIG. 2 includes example interface circuitry 300, example zero crossing detection circuitry 302, example phase selection controller 304, and example indexer circuitry 306.

The interface circuitry 300 of FIG. 3 obtains the total output current a terminal that is coupled to a reference node that represents the total output current. In some examples, the interface circuitry 300 may obtain a different signal corresponding to power converter efficiency (e.g., an output signal from a zero-voltage detection circuit). The interface 300 also outputs control signals to the control loop circuitry 224 identifying which phases 201, 203, 205 to enable or disable and when, based on the phase sequencing protocol.

The zero-crossing detection circuitry 302 of FIG. 3 detects when the total output becomes zero (e.g., changing from a positive current to a negative current or changing from a negative current to a positive current). The zero-cross detection circuitry 302 monitors the total output current based on the signal from a terminal. After the total output current becomes zero, the zero-crossing detection circuitry 302 outputs a pulse to the phase selection controller 304 and the indexer circuitry 306 to trigger a phase sequence for a duration of time until the total current reaches zero again.

The phase selection controller 304 of FIG. 3 determines a which phase of the power converter 200 to enable and when based on the total output current of the power converter 200. For example, during manufacturing and/or design, a hardware designer can determine an efficiency vs current relationship for each phase 201, 203, 205 of the power converter 200. The efficiency vs current relationship identifies the amount of current that corresponds to maximum efficiency for the phase. For example, the hardware designer can determine that the current corresponding to maximum efficiency is 5 amps for each phase 201, 203, 205. However, each phase could correspond to different amounts of current for maximum efficiency. The phase selection controller 304 is programmed to determine when the current reaches a current threshold that is set based on the maximum efficiency of the enabled phase(s). For example, for a particular duration of time, if the first phase 201 is enabled first, followed by the second phase 203, followed by the third phase 205, and the current threshold for all three phases corresponds to 5 amps, the phase selection controller 304 enables the first phase 201, while the second phase 203 and the third phase 205 are disabled, until the total output current reaches a first threshold of 5 amps. After the phase selection controller 304 determines that the total output current reaches 5 amps (e.g., based on a total output current signal), the phase selection controller 304 enables the first phase 201 and the second phase 203, while the third phase 205 is disabled. After the first and second phases 201, 203 are enabled, the phase selection controller 304 determines when the output current reaches a second threshold of 10 amps (e.g., 5 amps for the first phase plus 5 amps for the second phase). While the phase selection controller 304 determines that the total output current has reached the second threshold, the phase selection controller 304 enables the first, second, and third phases 201, 203, 205. While the phase selection controller 304 determines that the total output current no longer satisfies the second threshold while the three phases 201, 203, 205 are enabled (e.g., the current is less than 10 amps), the phase selection controller 304 disables the third phase 205 while the first and second phases 201, 203 are enabled. While the phase selection controller 304 determines that the total output current no longer satisfies the first threshold while the first and second phases 201, 203 are enabled and the third phase 205 is disabled (e.g., the current is less than 5 amps), the phase selection controller 304 disables the second and third phases 203, 205 while the first phase 201 are enabled. While the total current becomes zero (e.g., to switch from positive to negative current), the phase selection controller 304 will obtain a trigger from the zero-crossing detection circuitry 302 and the process will repeat for the negative current during a second duration of time. However, as further described below, the order of enablement (e.g., the order in which the phases are enabled/disabled) may be different for the second duration of time.

The indexer 306 of FIG. 3 adjusts the enablement order of the phases 201, 203, 205 for different durations of time (where each duration of time corresponds to a half period of the total current output). For example, the indexer 306 may select the enablement order for a first duration of time corresponding to first enabling phase 201, then enabling phase 203, then enabling phase 205. For a second duration of time subsequent the first duration of time, the indexer 306 may change the enablement order to first enabling phase 203, then enabling phase 205, then enabling phase 201. The indexer 306 can adjust the enablement order for each duration of time in any pattern (e.g., a repeated pattern, a random pattern, etc.). The indexer 306 provides the order of enablement to the phase selection controller 304 so that the phase selection controller 304 enables the phases 201, 203, 205 based on the order of enablement. Adjusting the order of enablement periodically (e.g., for each half period, period, every other period, etc. of the output current signal) balances/spreads out the wear and aging of the transistors and the thermal dissipation, thereby increasing the lifespan of the power converter 200. Thermal management and reduced wear may be especially important for GaN and SiC devices.

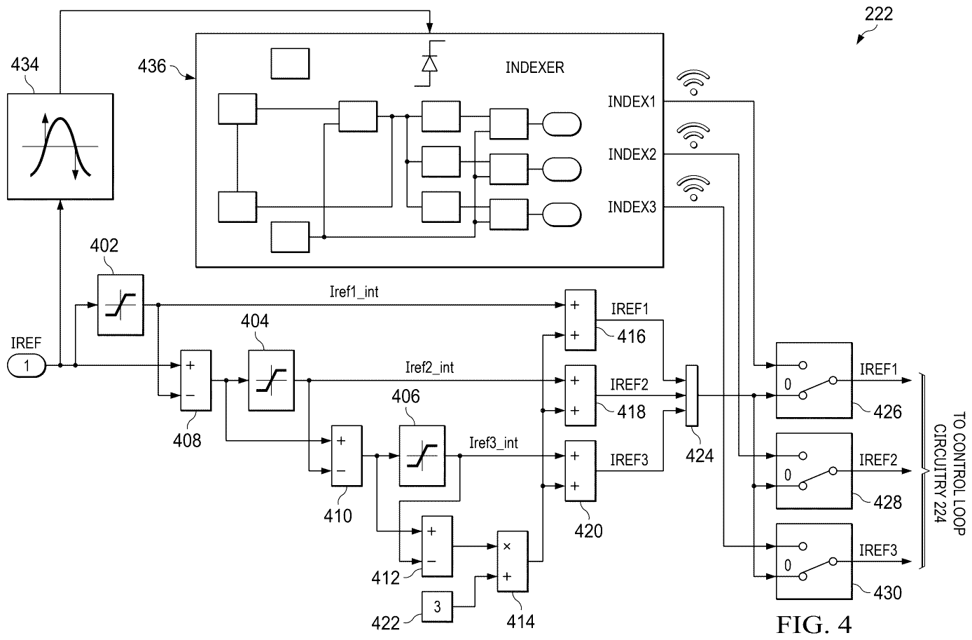

FIG. 4 is an example circuit implementation of the phase sequencing circuitry 222 of FIG. 2. The phase sequencing circuitry 222 of FIG. 4 includes example saturation circuitries 402, 404, 406, example subtractor circuitries 408, 410, 412, example divider circuitry 414, example adder circuitry 416, 418, 420, example signal source circuitry 422, an example bus 424, example switches 426, 428, 430, example zero-crossing detection circuitry 434, and example indexer circuitry 436. The example saturation circuitries 402, 404, 406, the example subtractor circuitries 408, 410, 412, the example divider circuitry 414, the example adder circuitries 416, 418, 420, the example signal source circuitry 422, and the example bus 424, example switches 426, 428, 430 may be used to implement the phase selection controller 304 of FIG. 3. The zero-crossing detection circuitry 434 may be used to implement the zero-cross detection circuitry 302 of FIG. 3. The indexer circuitry 438 may be used to implement the indexer circuitry 306 of FIG. 3. The phase sequencing circuitry 222 of FIG. 4 is structured to control the three-phase power converter circuitry 200 of FIG. 2. However, the phase sequencing circuitry 222 of FIG. 4 may be adjusted to control power converter circuitry with any number of phases.

The saturation circuitries 402, 404, 406 of FIG. 4 obtain a current signal or a signal representative of a current (e.g., a voltage that corresponds to a current) and output an output signal from zero to a maximum threshold. The maximum threshold for each saturation circuitry 402, 404, 406 is based on the current threshold for enabling a subsequent phase. For example, if input signal corresponds to a current less than the maximum threshold current the respective saturation circuitry 402, 404, 406, the corresponding saturation circuitry 402, 404, 406 outputs the input signal to one or more devices coupled to the output terminal of the respective saturation circuitry 402, 404, 406. However, if the total input current is more than the maximum threshold current, the corresponding saturation circuitry 402, 404, 406 outputs a signal corresponding to the maximum threshold current of the respective saturation circuitry 402, 404, 406 to one or more devices coupled to the output terminal of the respective saturation circuitry 402, 404, 406. For example, if the total output current from the reference terminal (e.g., corresponding to the total output current of the power converter 200) is 3 amps and the threshold of the saturation circuitry 402 corresponds to 5 amps, then the saturation circuitry 402 outputs a signal corresponding to 3 amps. However, if the total output current is 7 amps and the threshold of the saturation circuitry 402 corresponds to 5 amps, then the saturation circuitry 402 outputs a signal corresponding to 5 amps, because the maximum signal that the saturation circuitry 402 can output is a signal corresponding to 5 amps.

The saturation circuitry 402 of FIG. 4 includes an input terminal coupled to the reference terminal, the first input terminal of the subtractor circuitry 408, and the zero-crossing detection circuitry 434. The saturation circuitry 402 includes an output terminal coupled to the first input terminal of the adder circuitry 416 and the second input terminal of the subtractor circuitry 408. The saturation circuitry 404 includes an input terminal coupled to the output of the subtractor circuitry 408 and the first input of the subtractor circuitry 410. The saturation circuitry 404 includes an output terminal coupled to the first input terminal of the adder circuitry 418 and the second input terminal of the subtractor circuitry 410. The saturation circuitry 406 includes an input terminal coupled to the output of the subtractor circuitry 410 and the first input of the subtractor circuitry 412. The saturation circuitry 406 includes an output terminal coupled to the first input terminal of the adder circuitry 420 and the second input terminal of the subtractor circuitry 412.

The subtractor circuitries 408, 410, 412 of FIG. 4 output a signal that corresponds to a difference between (a) the signal at the input terminal of the respective subtractor circuitry 408, 410, 412 and (b) the signal at the second input terminal of the respective subtractor circuitry 408, 410, 412. For example, if the signal at the first input terminal of the subtractor circuitry 408 (e.g., corresponding to the total output current of the power converter 200) corresponds to 7 amps and the signal at the second input terminal of the subtractor circuitry 408 is 5 amps, the subtractor circuitry 408 outputs a signal corresponding to 2 amps (e.g., 7−5=2).

The subtractor circuitry 408 of FIG. 4 includes a first input terminal coupled to the reference terminal, the input terminal of the zero-crossing detection circuitry 434, and the input terminal of the saturation circuitry 402. The subtractor circuitry 408 includes a second input terminal coupled to the output terminal of the saturation circuitry 402 and the first input terminal of the adder circuitry 416. The subtractor circuitry 408 includes an output terminal coupled to the input terminal of the saturation circuitry 404 and the first input terminal of the subtractor circuitry 410. The subtractor circuitry 410 includes a first input terminal coupled to the output terminal of the subtractor circuitry 408 and the input terminal of the saturation circuitry 404. The subtractor 410 includes a second input terminal coupled to the output terminal of the saturation circuitry 404 and the first input terminal of the adder circuitry 418. The subtractor circuitry 410 includes an output terminal coupled to the input terminal of the saturation circuitry 406 and the first input terminal of the subtractor circuitry 412. The subtractor circuitry 412 includes a first input terminal coupled to the output terminal of the subtractor circuitry 410 and the input terminal of the saturation circuitry 406. The subtractor 412 includes a second input terminal coupled to the output terminal of the saturation circuitry 406 and the first input terminal of the adder circuitry 420. The subtractor circuitry 412 includes an output terminal coupled to the input terminal of the divider circuitry 414.

The divider circuitry 414 of FIG. 4 divides the signal output by the subtractor circuitry 412 by the value output by the signal source circuitry 422. The signal source circuitry 422 outputs a signal corresponding to the total number of phases. In FIG. 4, because the phase sequencing circuitry 222 controls a three-phase power converter, the signal source circuitry 422 outputs a signal corresponding to the three phases. Accordingly, the divider circuitry 414 divides the output signal of the subtractor 412 by three. In this manner, while all three phases are enabled, the excess current above a threshold is divided among the three phases. The divider circuitry 414 includes a first input terminal coupled to the output terminal of the subtractor circuitry 412. The divider circuitry 414 includes a second input terminal coupled to the output terminal of the signal source circuitry 422. The divider circuitry includes an output terminal coupled to the second input terminals of the adder circuitries 416, 418, 420.

The adder circuitries 416, 418, 420 of FIG. 4 output a signal that corresponds to a sum of (a) the signal at the first input terminal of the respective adder circuitry 416, 418, 420 and (b) the signal at the second input terminal of the respective adder circuitry 416, 418, 420. For example, if the signal at the first input terminal of the adder circuitry 416 (e.g., corresponding to the total output current of the power converter 200) corresponds to 5 amps and the signal at the second input terminal of the adder circuitry 416 is 1 amps, the adder circuitry 416 outputs a signal corresponding to 6 amps (e.g., 5+1=6). The output of the first adder 416 corresponds to the first phase to enable. The output of the second adder 418 corresponds to the second phase to enable. The output of the adder 420 corresponds to the third phase to enable.

The adder circuitry 416 of FIG. 4 includes a first input terminal coupled to the output terminal of the saturation circuitry 402 and the second input terminal of the subtractor circuitry 408. The adder circuitry 416 includes a second input terminal coupled to the output terminal of the divider circuitry 414. The adder circuitry 416 includes an output terminal coupled to the bus 424. The adder circuitry 418 includes a first input terminal coupled to the output terminal of the saturation circuitry 404 and the second input terminal of the subtractor circuitry 410. The adder circuitry 418 includes a second input terminal coupled to the output terminal of the divider circuitry 414. The adder circuitry 418 includes an output terminal coupled to the bus 424. The adder circuitry 420 includes a first input terminal coupled to the output terminal of the saturation circuitry 406 and the second input terminal of the subtractor circuitry 412. The adder circuitry 420 includes a second input terminal coupled to the output terminal of the divider circuitry 414. The adder circuitry 420 includes an output terminal coupled to the bus 424. The bus 424 provides the three output signals corresponding to three phases to the three switches 426, 428, 430.

The switches 426, 428, 430 of FIG. 4 each output one of the output signals from the adders 416, 418, 420 based on a signal from the indexer circuitry 436. The switch 426 corresponds to control of the first phase 201, the second switch 428 corresponds to control of the second phase 203, and the third switch 430 corresponds to control of the third phase 205. As further described below, the signal from the indexer circuitry 443634 corresponds to the enablement order for a duration of time (e.g., a half period of the total output current). For example, if the enablement order was to enable the second phase 203 first, the third phase 205 second, and the first phase 201 third, the indexer circuitry 436 would output a signal to each of the switches 426, 428, 430 so that (a) the switch 428 provides the output of the first adder circuitry 416 (e.g., corresponding to the first phase to enable) to the control loop circuitry 224, (b) the switch 430 provides the output of the second adder circuitry 418 (e.g., corresponding to the second phase to enable) to the control loop circuitry 224, and (c) the switch 426 provides the output of the third adder circuitry 420 (e.g., corresponding to the third phase to enable) to the control loop circuitry 224. In this manner, the control loop circuitry 224 can determine that the second phase 203 is enabled first, the third phase 205 is enabled second, and the first phase 201 is enabled third for the duration of time.

The zero-crossing detection circuitry 434 of FIG. 4 detects the total output current crossing zero (e.g., changing from a positive current to a negative current or changing from a negative current to a positive current). The zero-cross detection circuitry 434 monitors the total output current based on the signal from the reference terminal. After the total output current becomes zero, the zero-crossing detection circuitry 434 outputs a pulse to the indexer circuitry 436 to trigger the indexer circuitry 436 to change the enablement order. The zero-crossing detection circuitry 434 includes an input terminal coupled to the reference terminal, the input terminal of the saturation circuitry 402, and the first input terminal of the subtractor circuitry 408. The zero-crossing detection circuitry 434 includes an output terminal coupled to the indexer circuitry 436.

The indexer circuitry 436 of FIG. 3 adjusts the enablement order of the phases 201, 203, 205 for different durations of time (based on zero-crossing detection from the zero-cross detection circuitry 434). For example, the indexer circuitry 436 may select the enablement order for a first duration of time to corresponding to first enabling phase 201, then enabling phase 203, then enabling phase 205. For a second duration of time subsequent the first duration of time, the indexer circuitry 436 may change the enablement order to first enabling phase 203, then enabling phase 205, then enabling phase 203. The indexer circuitry 436 can adjust the enablement order for each duration of time in any pattern (e.g., a repeated pattern, a random pattern, etc.). The indexer circuitry 436 provides output signals to the switches 426, 428, 430 to cause the switches to output signal from the adders 416, 418, 420 (e.g., corresponding to when to enable different phases) based on the determined enablement order, as further described above. The indexer circuitry 436 includes an input terminal coupled to the output terminal of the zero-crossing detection circuitry 434. The indexer circuitry 436 includes a first output terminal coupled to the switch 426, a second output terminal coupled to the switch 428, and a third output terminal coupled to the switch 430.

In an example operation where the threshold to trigger enablement corresponds to increments of 5 amps, after the zero-crossing detection circuitry 434 detects a crossing from a positive current to a negative current or a negative current to a positive current, the zero-crossing detection circuitry 434 outputs a signal to the indexer circuitry 436 to generate an enablement order and control the switches 426, 428, 430 based on the enablement order to ensure that the phases are enabled based on the enablement order. If the total output current is low, 3 amps for example, the saturation circuitry 402 outputs a 3-amp signal because the 3-amp signal is less than the 5-amp threshold. Also, the subtractor circuitry 408 will subtract the 3-amp signal of the output of the saturation circuitry 402 with the 3-amp signal from the reference terminal, thereby resulting in a 0-amp output signal. Accordingly, the output signal of each saturation circuity 404, 406 is a 0-amp signal and the output of the divider 414 is a 0-amp signal. Thus, the adder circuitry 416 outputs a 3-amp signal and the adder circuitries 418, 420 output a 0-amp signal. Based on the enablement order, one of the switches 426, 428, 430 outputs the 3-amp signal to the control loop circuitry 224 and the other two switches 426, 428, 430 output the 0-amp signal to the control loop circuitry 224. In this manner, the control loop circuitry 224 enables a first phase, while a second and third phases are disabled according to the enablement order.

If the total output current is higher, 7 amps for example, the saturation circuitry 402 outputs a 5-amp signal because the 7-amp signal is larger than the 5-amp threshold. Also, the subtractor circuitry 408 will subtract the 5-amp signal of the output of the saturation circuitry 402 with the 7-amp signal from the reference terminal, thereby resulting in a 2-amp output signal. Accordingly, the output signal of the saturation circuity 404 will be a 2-amp signal. The subtractor circuitry 410 subtracts 2-amp signal of the saturation circuitry 404 is from the 2-amp signal of the subtractor circuitry 408, resulting in a 0-amp signal. Accordingly, the adder circuitry 416 outputs a 5-amp signal, the adder circuitry 418 outputs a 2-amp signal, and the adder circuitry 420 outputs a 0-amp signal. Based on the enablement order, one of the switches 426, 428, 430 outputs the 5-amp signal to the control loop circuitry 224, a second one of the switches 426, 428, 430 outputs the 2-amp signal to the control circuitry, and a third one of the switches 426, 428, 430 outputs the 0-amp signal to the control loop circuitry 224. In this manner, the control loop circuitry 224 enables a first phase and a second phase, while a third phase is disabled according to the enablement order.

If the total output current is high, 14 amps for example, the saturation circuitry 402 outputs a 5-amp signal because the 14-amp signal is larger than the 5-amp threshold. Also, the subtractor circuitry 408 will subtract the 5-amp signal of the output of the saturation circuitry 402 with the 14-amp signal from the reference terminal, thereby resulting in a 9-amp output signal. Accordingly, the output signal of the saturation circuity 404 will be a 5-amp signal because 9 amps is above the 5-amp threshold. The subtractor circuitry 410 subtracts the 5-amp signal of the saturation circuitry 404 from the 9-amp signal of the subtractor circuitry 408, resulting in a 4-amp signal. The saturation circuity 406 outputs the 4-amp signal because 4 amps is below the 5-amp threshold. Accordingly, the adder circuitry 416 outputs a 5-amp signal, the adder circuitry 418 outputs a 5-amp signal, and the adder circuitry 420 outputs a 4-amp signal. Based on the enablement order, one of the switches 426, 428, 430 outputs the 5-amp signal to the control loop circuitry 224, a second one of the switches 426, 428, 430 outputs the 5-amp signal to the control circuitry, and a third one of the switches 426, 428, 430 outputs the 4-amp signal to the control loop circuitry 224. In this manner, the control loop circuitry 224 enables all phases. If the total output current is very high (e.g., above 15 amps), the subtractor circuitry 412 can determine the amount of current above a threshold (e.g., 15 amps) and the divider circuitry 414 divides the amount of current above 15 amps by the and distribute the quotient between the phases via the adder circuitry 416, 418, 420.

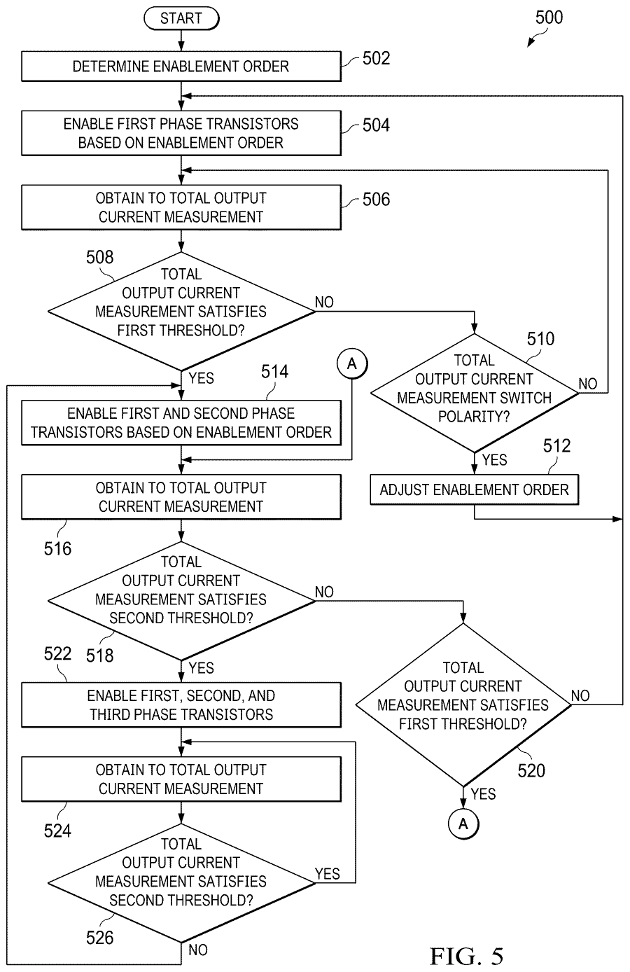

FIG. 5 is a flowchart representative of a method and/or example operations 500 that may be executed and/or instantiated by the phase sequencing circuitry 222 of FIGS. 2, 3, and/or 4. The operations 500 can be performed by any one or combination of the circuitry shown in FIGS. 2-4. Although the instructions and/or operations of FIG. 5 are described in conjunction with the power converter 200 of FIG. 2, the instructions and/or operations may be described in conjunction with any type of circuit that implements processing circuitry. Some processes shown in FIG. 5 may be performed in orders other than described, and many processes may be performed concurrently in parallel. Furthermore, processes shown in FIG. 5 may be omitted or substituted in some examples of the present description. Although the example of FIG. 5 is described in conjunction with a three-phase power converter, FIG. 5 can be modified for a power converter with any number of phases.

The machine-readable instructions and/or the operations 500 of FIG. 5 begin at block 502, at which the indexer circuitry 306 determines the enablement order. As described above, the enablement order is the order of which phase will be enabled first, then second, and then third for a duration of time. While disabling phases, the enablement order is reversed. For example, for an enablement order, the phase enabled first is the phase that is disabled last and the phase that is enabled last is disabled first. At block 504, the phase selection controller 304 outputs a signal to the control loop circuitry 224 to enable first phase transistors based on the enablement order. For example, if the enablement order defines the phase 201 as the first phase to enable, the phase selection controller 304 outputs a signal to the control loop circuitry to enable control of the transistors 202, 204 of the first phase 201. At block 506, the interface circuitry 300 obtains a total output current measurement (e.g., a signal representative of the total output current) from the reference terminal.

At block 508, the phase selection controller 304 determines if the total output current measurement satisfies (e.g., is greater than) a first threshold. As described above, the first threshold corresponds to the amount of current drawn by the transistors of the first phase that results in above a threshold amount of efficiency for the transistors. If the first threshold is 10 amps, then the phase selection controller 304 determines if the total output current measurement is above the 10-amp threshold. If the phase selection controller 304 determines that that the total output current measurement satisfies the first threshold (block 508: YES), control continues to block 514, as further described below. If the phase selection controller 304 determines that that the total output current measurement does not satisfy the first threshold (block 508: NO), the phase selection controller 304 determines if the total output current measurement has switched polarity (e.g., if the total output current went from positive current to negative current or vice versa) (block 510). If the phase selection controller 304 determines that the total output current measurement has not switched polarity (block 510: NO), control returns to block 506. If the phase selection controller 304 determines that the total output current measurement has switched polarity (block 510: YES), the indexer circuitry 305 adjusts the enablement order (block 512) and control returns to block 504.

If the phase selection controller 304 determines that that the total output current measurement satisfies the first threshold (block 508: YES), the phase selection controller 304 provides a signal to the control loop circuitry 224 to enable the first phase and the second phase transistors based on the enablement order (block 514). At block 516, the interface circuitry 300 obtains the total output current of the power converter 200 from the reference terminal. At block 518, the phase selection controller 304 determines if the total output current measurement satisfies (e.g., is greater than) a second threshold. As described above, the second threshold corresponds to the amount of current drawn by the transistors of the second phase and the second phase that results in above a threshold amount of efficiency for the transistors. If the second threshold is 15 amps, then the phase selection controller 304 determines if the total output current measurement is above the 15-amp threshold.

If the phase selection controller 304 determines that the total output current measurement satisfies the second threshold (block 518: YES), control continues to block 522, as further described below. If the phase selection controller 304 determines that the total output current measurement does not satisfy the second threshold (block 518: NO), the phase selection controller 304 determines if the total output current measurement satisfies (e.g., is greater than) the first threshold (block 520). If the phase selection controller 304 determines that the total output current measurement satisfies the first threshold (block 520: YES), control returns to block 516. If the phase selection controller 304 determines that the total output current measurement does not satisfy the first threshold (block 520: NO), control returns to block 504.

If the phase selection controller 304 determines that the total output current measurement satisfies the second threshold (block 518: YES), the phase selection controller 304 provides a signal to the control loop circuitry 224 to enable the first phase, the second phase, and the third phase transistors (block 522). At block 524, the interface circuitry 300 obtains the total output current measurement of the power converter 200 from the reference terminal. At block 526, the phase selection controller 304 determines if the total output current measurement satisfies (e.g., is greater than) the second threshold. If the phase selection controller 304 determines that the total output measurement satisfies the second threshold (block 526: YES), control returns to block 524. If the phase selection controller 304 determines that the total output measurement does not satisfy the second threshold (block 526: NO), control returns to block 514.

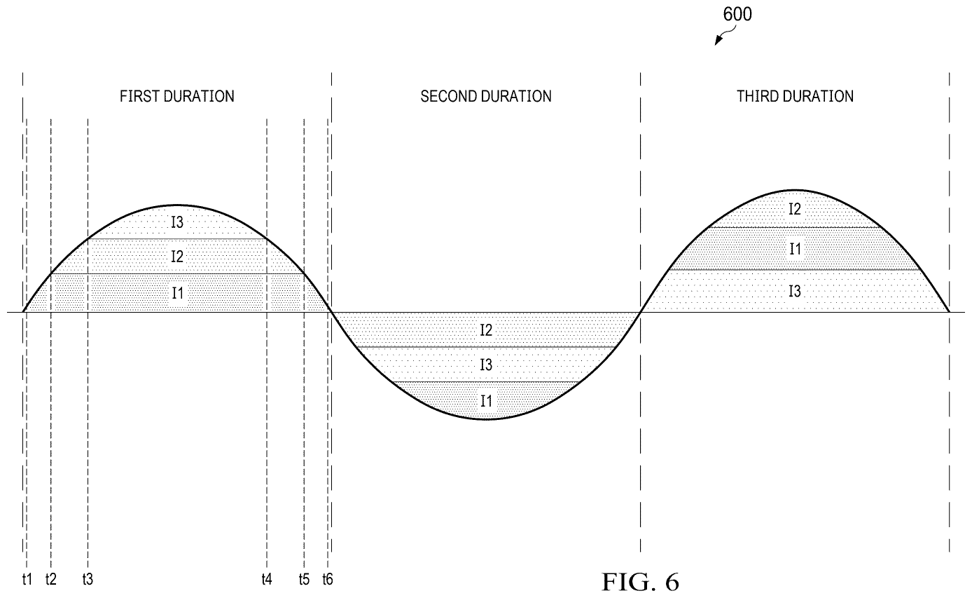

FIG. 6 is an example total current diagram 600 illustrating the total output current of the power converter 200 during a first duration, a second duration, and a third duration for different enablement orders. The first duration in FIG. 6 is a first switching cycle for the power converter 200, the second duration is a second switching cycle, and the third duration is a third switching cycle. Although the example shown in FIG. 6 includes three phases, the techniques of this disclosure may be implemented in systems have a different number of phases, such as two phases or more than three phases.

At time t1, the zero-crossing detection circuitry 302 determines that the total output current is zero and triggers the indexer circuitry 306 to generate an enablement order for the first duration of time (e.g., half the period of the total output current). For the first duration of time, the indexer circuitry 306 determines that the enablement order corresponds to enabling the first phase 201 of FIG. 1, then the second phase 203 of FIG. 1, and then the third phase 205 of FIG. 1. After the indexer circuitry 306 determines the enablement order, the phase selection controller 304 outputs a signal to the control loop circuitry 224 to enable the transistors 202, 204 of the first phase 201 while the phases 203, 205 are disabled.

At time t2, the phase selection controller 304 determines that the total output current has reached the first threshold and the phase selection controller 304 outputs a signal to the control loop circuitry 224 to enable the transistors 206, 208 of the second phase 203, while the first phase 201 is enabled and the third phase 203 is disabled. At time t3, the phase selection controller 304 determines that the total output current has reached the second threshold and the phase selection controller 304 outputs a signal to the control loop 224 to enable the transistors 210, 212 of the third phase 205, while the first phase 201 and the second phase 203 are enabled. At time t4, the phase selection controller 304 determines that the total output current has decreased below the second threshold and the phase selection controller 304 outputs a signal to the control loop circuitry 224 to disable the transistors 210, 212 of the third phase 205, while the first phase 201 and the second phase 203 are enabled. At time t5, the phase selection controller 304 determines that the total output current has decreased below the first threshold and the phase selection controller 304 outputs a signal to the control loop circuitry 224 to disable the transistors 206, 208 of the second phase 203, while the first phase 201 is enabled and the third phase 205 is disabled. At time t6, the indexer circuitry 306 determines that the total output current has reached zero, crossed zero, and/or gone negative and the phase selection controller 304 outputs a signal to the control loop circuitry 224 to disable the transistors 202, 204 of the first phase 201, while the second phase 203 and third phase 205 are disabled. Also, at time t6, the indexer circuitry 306 changes the enablement order to first enable the phase 203, then enable the phase 205, and then enable the phase 201 for the second duration and the process repeats for the adjusted enablement order. After the second duration is complete and the zero-crossing circuitry determines that the total output current changes from negative to positive, the indexer circuitry 306 changes the enablement order to first enable the phase 205, then enable the phase 201, and then enable the phase 203 for the third duration and the process repeats for the adjusted enablement order.

Thus, the phase selection controller 304 may be configurable to activate the first phase at the beginning of the switching cycle, time t1. The phase selection controller 304 may be configurable to then activate the second phase in response to determining that the output current satisfies a first threshold at time t2. In other words, the phase selection controller 304 can use the first phase to provision the entire load until the output current reaches the first threshold at time t2. The phase selection controller 304 may be configurable to then activate the third phase in response to determining that the output current satisfies a second threshold at time t3.

The phase selection controller 304 may be configurable to deactivate the third phase in response to determining that the output current satisfies the second threshold at time t4, deactivate the second phase in response to determining that the output current satisfies the first threshold at time t5, and deactivate the first phase at the end of the switching cycle at time t6. As shown in FIG. 6, the phase selection controller 304 can change the phase order for subsequent switching cycles. In addition, the selection controller 304 may be configurable to activate only two phases for light load conditions.

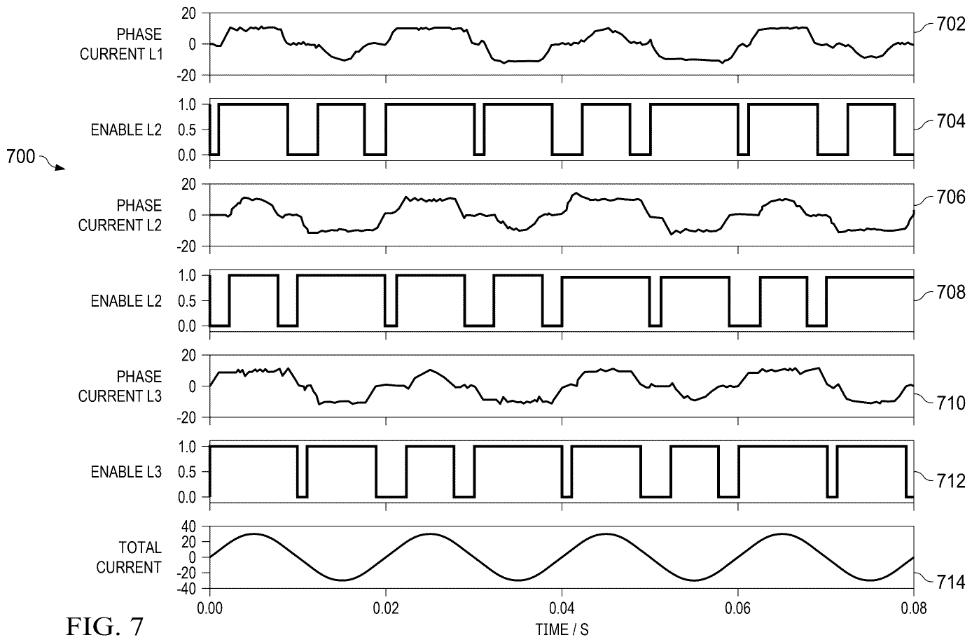

FIG. 7 is an example graph 700 illustrating various control and current signals throughout the power converter 200 of FIG. 2. The graph 700 of FIG. 7 includes an example current output 702 of the first phase 201, an example control signal 704 output by the phase sequencing circuitry 222 to enable the first phase 201, an example current output 706 of the second phase 203, an example control signal 708 output by the phase sequencing circuitry 222 to enable the second phase 203, an example current output 710 of the third phase 205, an example control signal 712 output by the phase sequencing circuitry 222 to enable the third phase 205, and a total output current 714 output by the power converter 200. The total output current 714 is a sum of the output currents 702, 706, 710 of all three phases 201, 203, 205.

In the example of FIG. 7, for a first duration of time, the third phase 205 is enabled first, as shown in the high signal of the control signal 712. Accordingly, the current signal 710 for the third phase 205 increases until it reaches a maximum. At this point, the first phase 201 is enabled while the third phase 205 is enabled, as shown in the high signal of the control signal 704. Thus, while the current signal 710 is flat, the first current signal 702 increases until it reaches a maximum. At this point, the second phase 203 is enabled while the first and third phases 201, 205 are enabled, as shown in the high signal of the control signal 708. Thus, while the current signal signals 702, 710 are flat, the second current signal 706 increases until it reaches a maximum and then decreases. As the total current reduces below each threshold, the phases are disable based on the enablement order (e.g., disable the second phase 203 first, the first phase 201 second, and the third phase 205 last). The process is then repeated for a different enablement order.

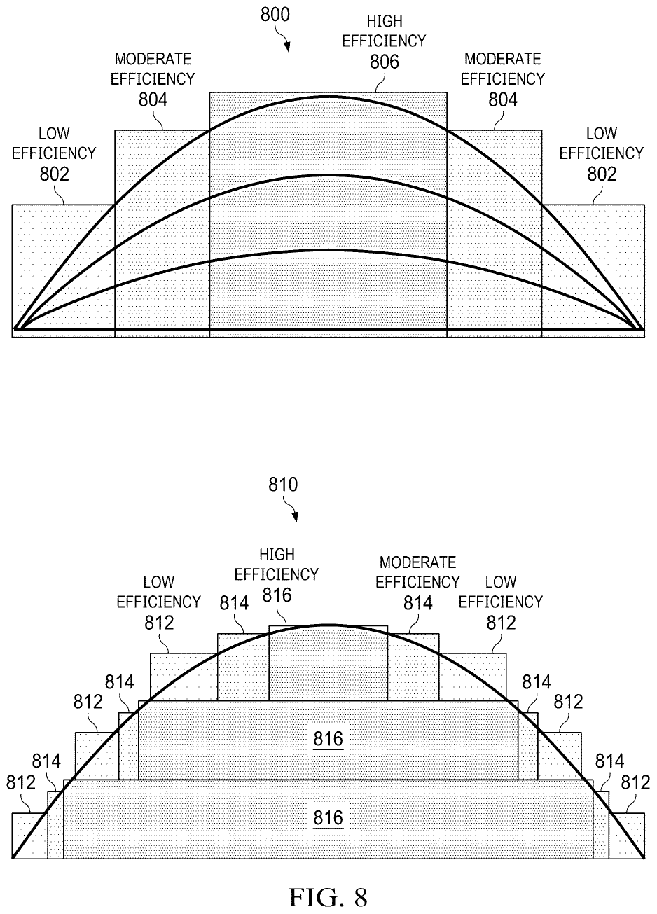

FIG. 8 illustrates a comparison of the efficiency of some power converters to the efficiency of the power converter 200 of FIG. 2. FIG. 8 includes a first example efficiency illustration 808 corresponding to control of some power converter that enable all phases at the same time throughout operation. FIG. 8 further includes a second example efficiency illustration 810 corresponding to control of the power converter 200 of FIG. 2 using the phase sequencing technique described herein. The first illustration 800 includes first example rectangles 802 representative of poor efficiency of a power converter, second example rectangles 804 representative of moderate efficiency of a power converter, and a third example rectangle 806 representative of high efficiency of a power converter for a duration of time. The second illustration 810 includes first example rectangles 812 representative of poor efficiency of the power converter 200, second example rectangles 814 representative of moderate efficiency of the power converter 200, and a third example rectangle 816 representative of high efficiency of the power converter 200 for the duration of time.

Because some power converters enable all phases for the entire duration of time, when first enabled, all phases operate with low efficiency, then operate with medium efficiency, then operate with high efficiency, as shown in the first illustration 800. However, using examples disclosed herein, the first phase is enabled so that only the first phase operates in low efficiency. After the first phase reaches high efficiency, the second phase is enabled so that only the second phase operates in low efficiency. After the second phase reaches high efficiency, the third phase is enabled so that only the third phase operates in low efficiency. Examples disclosed herein result in a total area of the high efficiency rectangles 816 that is higher than the total area of the high efficiency rectangle 806. Also, examples disclosed herein result in a total area of the low efficiency rectangles 812 that is lower than the total area of the low efficiency rectangles 802. Accordingly, examples described herein result in higher efficiency than other power converters.

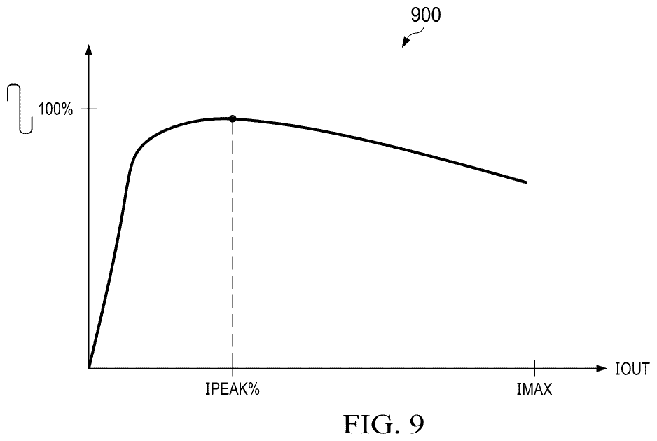

FIG. 9 is an example graph 900 illustrating the efficiency of an example phase of the multi-phase power converter 200 of FIG. 2 with respect to the current output by the phase. The x-axis of the graph 900 corresponds to output current of the example phase and the y-axis of the graph 900 corresponds to efficiency of the phase of the converter. As shown in the graph 900, when the current output by a phase is low, the efficiency is also low. However, the efficiency increases as the current increases to a peak and then starts to decrease slowly. Accordingly, the current threshold for enabling the phase can be selected based on the graph 900 (e.g., when the current for the phase reaches a threshold amount of efficiency). For example, a designer or user may program the current threshold into the device, and the device may be configurable to activate another phase when the current satisfies the threshold.

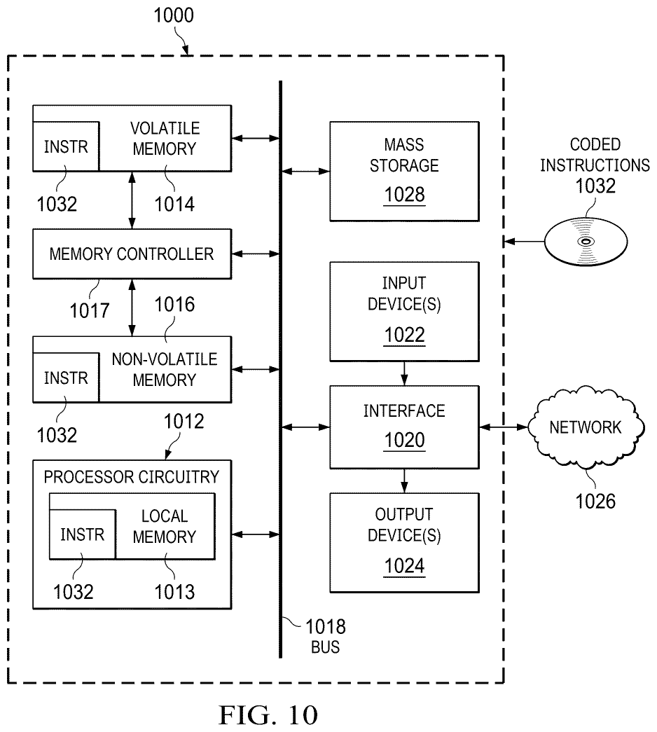

FIG. 10 is a block diagram of an example programmable circuitry platform 1000 structured to execute and/or instantiate the example machine-readable instructions and/or the example operations of FIG. 5 to implement the phase sequencing circuitry 222 of FIG. 3. The programmable circuitry platform 1000 can be, for example, a server, a personal computer, a microcontroller, logic, an FPGA, or any other type of computing and/or electronic device.

The programmable circuitry platform 1000 of the illustrated example includes programmable circuitry 2012. The programmable circuitry 2012 of the illustrated example is hardware. For example, the programmable circuitry 2012 can be implemented by one or more integrated circuits, logic circuits, FPGAs, microprocessors, CPUs, GPUs, VPUs, DSPs, and/or microcontrollers from any desired family or manufacturer. The programmable circuitry 2012 may be implemented by one or more semiconductor based (e.g., silicon based) devices. In this example, the programmable circuitry 2012 implements the zero-crossing detection circuitry 302, the phase selection controller 304, and the indexer circuitry 306.

The programmable circuitry 2012 of the illustrated example includes a local memory 2013 (e.g., a cache, registers, etc.). The programmable circuitry 2012 of the illustrated example is in communication with main memory 2014, 2016, which includes a volatile memory 2014 and a non-volatile memory 2016, by a bus 2018. The volatile memory 2014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2016 may be implemented by flash memory and/or any other desired type of memory device. Access to the main memory 2014, 2016 of the illustrated example is controlled by a memory controller 2017. In some examples, the memory controller 2017 may be implemented by one or more integrated circuits, logic circuits, microcontrollers from any desired family or manufacturer, or any other type of circuitry to manage the flow of data going to and from the main memory 2014, 2016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. The interface circuitry 1020 may implement the interface circuitry 300 of FIG. 3.

In the illustrated example, one or more input devices 1022 are connected to the interface circuitry 1020. The input device(s) 1022 permit(s) a user (e.g., a human user, a machine user, etc.) to enter data and/or commands into the programmable circuitry 2012. The input device(s) 1022 can be implemented by, for example, an audio sensor, a microphone, a camera (still or video), a keyboard, a button, a mouse, a touchscreen, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 2032, which may be implemented by the machine readable instructions of FIG. 5, may be stored in the mass storage device 1028, in the volatile memory 2014, in the non-volatile memory 2016, and/or on at least one non-transitory computer readable storage medium such as a CD or DVD which may be removable.

An example manner of implementing the phase sequencing circuitry 222 of FIG. 3 is illustrated in FIG. 5. However, one or more of the elements, processes and/or devices illustrated in FIG. 5 may be combined, divided, re-arranged, omitted, eliminated, and/or implemented in any other way.

Further, the interface circuitry 300, the zero-crossing detection circuitry 302, the phase selection controller 304, the indexer circuitry 306, and/or, more generally, the phase sequencing circuitry 222 of FIG. 3 may be implemented by hardware, software, firmware and/or any combination of hardware, software and/or firmware. As a result, for example, any the interface circuitry 300, the zero-crossing detection circuitry 302, the phase selection controller 304, the indexer circuitry 306, and/or, more generally, the phase sequencing circuitry 222 of FIG. 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the interface circuitry 300, the zero-crossing detection circuitry 302, the phase selection controller 304, the indexer circuitry 306, and/or, more generally, the phase sequencing circuitry 222 of FIG. 3 is/are hereby expressly defined to include a non-transitory computer readable storage device or storage disk such as a memory, a digital versatile disk (DVD), a compact disk (CD), a Blu-ray disk, etc., including the software and/or firmware. Further still, the interface circuitry 300, the zero-crossing detection circuitry 302, the phase selection controller 304, the indexer circuitry 306, and/or, more generally, the phase sequencing circuitry 222 of FIG. 3 may include one or more elements, processes and/or devices in addition to, or instead of, those illustrated in FIG. 5, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

Flowcharts representative of example hardware logic, machine-readable instructions, hardware implemented state machines, and/or any combination thereof for implementing the phase sequencing circuitry 222 of FIG. 2 is shown in FIGS. 3 and/or 4. The machine-readable instructions may be one or more executable programs or portion(s) of an executable program for execution by a computer processor. The program may be embodied in software stored on a non-transitory computer readable storage medium such as a CD-ROM, a floppy disk, a hard drive, a DVD, a Blu-ray disk, or a memory associated with the processor, but the entire program and/or parts thereof could alternatively be executed by a device other than the processor and/or embodied in firmware or dedicated hardware.

Further, although the example program is described with reference to the flowcharts illustrated in FIG. 5, many other methods of implementing the phase sequencing circuitry 222 may alternatively be used. For example, the order of execution of the blocks may be changed, and/or some of the blocks described may be changed, eliminated, or combined. Also or alternatively, any or all of the blocks may be implemented by one or more hardware circuits (e.g., discrete and/or integrated analog and/or digital circuitry, a field-programmable gate array (FPGA), an application-specific integrated circuit (ASIC), a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, in which the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. As a result, the described machine-readable instructions and/or corresponding program(s) encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C-sharp, Perl, Python, JavaScript, HyperText Markup Language (HTML), Structured Query Language (SQL), Swift, etc.

As mentioned above, the example processes of FIG. 3 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein when identifying multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for ease of referencing multiple elements or components.

In the description and in the claims, the terms “including” and “having” and variants thereof are to be inclusive in a manner similar to the term “comprising” unless otherwise noted. Unless otherwise stated, “about,” “approximately,” or “substantially” preceding a value means +/−10 percent of the stated value. In another example, “about,” “approximately,” or “substantially” preceding a value means +/−5 percent of the stated value. IN another example, “about,” “approximately,” or “substantially” preceding a value means +/−1 percent of the stated value.

The term “couple” “coupled”, “couples”, and variants thereof, as used herein, may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A. Moreover, the terms “couple,” “coupled,” “couples,” or variants thereof, includes an indirect or direct electrical or mechanical connection.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIGS. 1-2, components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal,” “node,” “interconnect,” “pad,” and “pin” may be used interchangeably.

The terms “or” and “and/or” as used, for example, in a form such as A, B, or C or A, B, and/or C refers to any combination or subset of A, B, C such as (1) A alone, (2) B alone, (3) C alone, (4) A with B, (5) A with C, (6) B with C, or (7) A with B and with C.

Example methods, apparatus, systems, and articles of manufacture for phase sequencing for multi-phase power converters are described herein. Further examples and combinations thereof include the following: Example 1 includes a device comprising interface circuitry configurable to couple to a first phase of a power converter and a second phase of the power converter, and processing circuitry coupled to the interface circuitry and configurable to enable the first phase while the second phase is disabled, responsive to an output current of the power converter satisfying a first threshold after enabling the first phase, enable the first phase and the second phase, and responsive to the output current not satisfying the first threshold after enabling the second phase, disable the second phase while the first phase is enabled.

Example 2 includes the device of example 1, wherein the processing circuitry is configurable to responsive to the output current of the power converter satisfying a second threshold after enabling the first phase and the second phase, enable a third phase of the power converter while the first and second phases are enabled, and responsive to the output current not satisfying the second threshold after enabling the third phase, disable the third phase while the first phase and the second phase are enabled.

Example 3 includes the device of example 1, wherein the processing circuitry is configurable to disable a third phase of the power converter while the first phase is enabled and the second phase is disabled.

Example 4 includes the device of example 1, wherein the processing circuitry is configurable to, responsive to the output current of the power converter satisfying the first threshold after enabling the first phase, enable the first phase and the second phase while a third phase of the power converter is disabled.

Example 5 includes the device of example 1, wherein the processing circuitry is configurable to, responsive to the output current not satisfying a second threshold, disable the first phase, wherein the second threshold is lower than the first threshold.

Example 6 includes the device of example 1, wherein the processing circuitry is configurable to receive a signal representative of the output current of the power converter from a sensor.

Example 7 includes the device of example 1, further including control loop circuitry configurable to, based on one or more control signals corresponding to the enabling or disabling of the first and second phases, control one or more first transistors when the first phase is enabled and control one or more second transistors when the second phase is enabled.

Example 8 includes the device of example 1, wherein the processing circuitry is configurable to adjust an enablement order of the first and second phases for different durations of time.

Example 9 includes the device of example 1, wherein the processing circuitry is configurable to after disabling the second phase, disable the first phase, and after disabling the first phase, enable the second phase while the first phase is disabled.

Example 10 includes the device of example 1, wherein the processing circuitry is configurable to operate the first phase at a constant level while the second phase is enabled.

Example 11 includes a method comprising enabling a first phase of a power converter while a second phase of the power converter is disabled, responsive to an output current of the power converter satisfying a first threshold after enabling the first phase, enabling the first phase and the second phase, and responsive to the output current not satisfying the first threshold after enabling the second phase, disabling the second phase while the first phase is enabled.

Example 12 includes the method of example 11, further including responsive to the output current of the power converter satisfying a second threshold after enabling the first phase and the second phase, enabling a third phase of the power converter while the first and second phases are enabled, and responsive to the output current not satisfying the second threshold after enabling the third phase, disabling the third phase while the first phase and the second phase are enabled.

Example 13 includes the method of example 11, further including disabling a third phase of the power converter while the first phase is enabled and the second phase is disabled.

Example 14 includes the method of example 11, further including, responsive to the output current of the power converter satisfying the first threshold after enabling the first phase, enabling the first phase and the second phase while a third phase of the power converter is disabled.

Example 15 includes the method of example 11, further including, based on one or more control signals corresponding to the enabling or disabling of the first and second phases, controlling one or more first transistors when the first phase is enabled and control one or more second transistors when the second phase is enabled.

Example 16 includes the method of example 11, further including adjusting an enablement order of the first and second phases for different durations of time.

Example 17 includes the method of example 11, further including after disabling the second phase, disabling the first phase, and after disabling the first phase, enabling the second phase while the first phase is disabled.

Example 18 includes a system comprising a power converter including a first phase circuit configurable to generate a first current and a second phase circuit configurable to generate a second current, wherein a total output current of the power converter corresponds to a sum of the first current and the second current, and a controller configurable to enable the first phase circuit while the second phase circuit is disabled, responsive to the total output current satisfying a threshold after enabling the first phase circuit, enable the first phase circuit and the second phase circuit, and responsive to the total output current not satisfying the threshold after enabling the second phase circuit, disable the second phase circuit while the first phase circuit is enabled.

Example 19 includes the system of example 18, wherein the controller includes a first current limiter configurable to limit the total output current to a first value corresponding to the threshold, and subtractor circuitry to generate a difference value based on a difference between the total output current and the first value, wherein the controller is configurable to enable the first phase circuit and the second phase circuit based on the difference value being greater than zero.

Example 20 includes the system of example 18, wherein the controller configurable to after disabling the second phase circuit, disable the first phase circuit, and after disabling the first phase circuit, enable the second phase circuit while the first phase circuit is disabled.

Modifications are possible in the described embodiments, and other embodiments are possible, within the scope of the claims.

What is claimed is:

1. A device comprising:
interface circuitry configurable to couple to a first phase of a power converter and a second phase of the power converter; and
processing circuitry coupled to the interface circuitry and configurable to:
enable the first phase while the second phase is disabled;
responsive to an output current of the power converter satisfying a first threshold after enabling the first phase, enable the first phase and the second phase; and
responsive to the output current not satisfying the first threshold after enabling the second phase, disable the second phase while the first phase is enabled.

2. The device of claim 1, wherein the processing circuitry is configurable to:
responsive to the output current of the power converter satisfying a second threshold after enabling the first phase and the second phase, enable a third phase of the power converter while the first and second phases are enabled; and
responsive to the output current not satisfying the second threshold after enabling the third phase, disable the third phase while the first phase and the second phase are enabled.

3. The device of claim 1, wherein the processing circuitry is configurable to disable a third phase of the power converter while the first phase is enabled and the second phase is disabled.

4. The device of claim 1, wherein the processing circuitry is configurable to, responsive to the output current of the power converter satisfying the first threshold after enabling the first phase, enable the first phase and the second phase while a third phase of the power converter is disabled.

5. The device of claim 1, wherein the processing circuitry is configurable to, responsive to the output current not satisfying a second threshold, disable the first phase, wherein the second threshold is lower than the first threshold.

6. The device of claim 1, wherein the processing circuitry is configurable to receive a signal representative of the output current of the power converter from a sensor.

7. The device of claim 1, further including control loop circuitry configurable to, based on one or more control signals corresponding to the enabling or disabling of the first and second phases, control one or more first transistors when the first phase is enabled and control one or more second transistors when the second phase is enabled.

8. The device of claim 1, wherein the processing circuitry is configurable to adjust an enablement order of the first and second phases for different durations of time.

9. The device of claim 1, wherein the processing circuitry is configurable to:
after disabling the second phase, disable the first phase; and
after disabling the first phase, enable the second phase while the first phase is disabled.

10. The device of claim 1, wherein the processing circuitry is configurable to operate the first phase at a constant level while the second phase is enabled.

11. A method comprising:
enabling a first phase of a power converter while a second phase of the power converter is disabled;
responsive to an output current of the power converter satisfying a first threshold after enabling the first phase, enabling the first phase and the second phase; and
responsive to the output current not satisfying the first threshold after enabling the second phase, disabling the second phase while the first phase is enabled.

12. The method of claim 11, further including:
responsive to the output current of the power converter satisfying a second threshold after enabling the first phase and the second phase, enabling a third phase of the power converter while the first and second phases are enabled; and
responsive to the output current not satisfying the second threshold after enabling the third phase, disabling the third phase while the first phase and the second phase are enabled.

13. The method of claim 11, further including disabling a third phase of the power converter while the first phase is enabled and the second phase is disabled.

14. The method of claim 11, further including, responsive to the output current of the power converter satisfying the first threshold after enabling the first phase, enabling the first phase and the second phase while a third phase of the power converter is disabled.

15. The method of claim 11, further including, based on one or more control signals corresponding to the enabling or disabling of the first and second phases, controlling one or more first transistors when the first phase is enabled and control one or more second transistors when the second phase is enabled.

16. The method of claim 11, further including adjusting an enablement order of the first and second phases for different durations of time.

17. The method of claim 11, further including:
after disabling the second phase, disabling the first phase; and
after disabling the first phase, enabling the second phase while the first phase is disabled.

18. A system comprising:
a power converter including a first phase circuit configurable to generate a first current and a second phase circuit configurable to generate a second current, wherein a total output current of the power converter corresponds to a sum of the first current and the second current; and
a controller configurable to:
enable the first phase circuit while the second phase circuit is disabled;
responsive to the total output current satisfying a threshold after enabling the first phase circuit, enable the first phase circuit and the second phase circuit; and
responsive to the total output current not satisfying the threshold after enabling the second phase circuit, disable the second phase circuit while the first phase circuit is enabled.

19. The system of claim 18, wherein the controller includes:
a first current limiter configurable to limit the total output current to a first value corresponding to the threshold; and
subtractor circuitry to generate a difference value based on a difference between the total output current and the first value,
wherein the controller is configurable to enable the first phase circuit and the second phase circuit based on the difference value being greater than zero.

20. The system of claim 18, wherein the controller configurable to:
after disabling the second phase circuit, disable the first phase circuit; and
after disabling the first phase circuit, enable the second phase circuit while the first phase circuit is disabled.
